(19) United States
(12) Patent Application Publication
(10) Pub. No.: US 2004/0081596 A1
(43) Pub. Date: Apr. 29, 2004

(54) Device case and air purifier arrangement

(76) Inventor: Cheng Huang Hsi, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/277,942

(22) Filed: Oct. 23, 2002

(51) Int. Cl. B01J 19/08

(52) U.S. Cl. 422/186.3

(57) ABSTRACT

A device case and air purifier arrangement includes a case body having an air input port and an air output port in front and back sides thereof and a TiO₂ coated wire gauze filter covering the air input port, a ultraviolet lamp provided above the TiO₂ coated wire gauze filter and adapted to emit ultraviolet light onto the TiO₂ coated wire gauze filter, and an air purifier mounted inside the case body between the air input port and the air output port, the air purifier using induced-draft fans to induce currents of air through the case body, a TiO₂ coated air filter to remove solid matter from the air passing through, and ultraviolet lamps to sterilize air passing through the air filter.

### BACKGROUND OF THE INVENTION

1. Field of the Invention

The present invention relates to device cases and, more specifically, to a device case and air purifier arrangement that purges germs and peculiar smell from the air passing through.

2. Description of the Related Art

When radiated by ultraviolet light, photo catalyst (titanium dioxide) produces a strong oxidation effect to decompose waste and organic matter in air. Therefore, photo catalyst products are ideal for environmental protection, and photocatalytic approaches to control the chemical sensitivity syndrome. Further, various commercially available purifiers use ultraviolet lamps to sterilize air and water.

FIGS. 1 and 2 show a computer case having air purifier means. According to this design, the case body 10 of the computer case has an air input port 14 in the metal front face panel 12, a wire gauze filter 16 covering the air input port 14, and an inside locating plate 18 supporting a ultraviolet lamp 20 and an induced-draft fan 22. During the operation of the computer, induced currents of air pass from the air input port 14 to the air output port 24 in the back panel of the case body 10 to carry heat out of the case body 10, and at the same time the ultraviolet lamp 20 emit ultraviolet light to sterilize the air. This design of computer case simply roughly purifies the air. It does not purge germs and peculiar smell from the air satisfactorily.

### SUMMARY OF THE INVENTION

It is the main object of the present invention to provide a device case and air purifier arrangement, which improves ventilation of air through the device case. It is another object of the present invention to provide a device case and air purifier arrangement, which purge germs and peculiar smell from the air passing through. To achieve these and other objects of the present invention, the device case and air purifier arrangement comprises a case body, said case body having at least one air port in a front face panel thereof and at least one air output port in a back panel thereof, the front face panel of said case body having an inner side coated with a layer of photo catalyst of titanium dioxide; a locating plate coated with a layer of photo catalyst of titanium dioxide and fastened to the inner side of the front face panel inside the case body; at least one ultraviolet light source mounted in the locating plate inside the case body above the at least one air input port of the case body; a wire gauze filter coated with a layer of photo catalyst of titanium dioxide and mounted in between the front face panel of the case body and the locating plate over the at least one air input port of the case body; and an air purifier mounted inside the case body and adapted to induce currents of air through the at least one air input port and at least one air output port of the case body and to purify the air passing through, the air purifier comprising a grilled housing coated with a layer of photo catalyst of titanium dioxide and fixedly fastened to the locating plate, an air filter mounted within the grilled housing, a metal rack coated with a layer of photo catalyst of titanium dioxide and mounted inside the grilled housing to support the air filter in place, a cover covered on the grilled housing to hold the rack and the air filter inside the grilled housing, the cover having at least one air passage hole adapted to guide air from the at least one air input port of the case body to the at least one air output port of the case body, at least one ultraviolet light source installed in the cover inside the grilled housing, and at least one induced-draft fan respectively mounted in the at least one air passage hole of the cover.

### BRIEF DESCRIPTION OF THE DRAWINGS

FIG. 1 is an oblique front elevational view, partially cutaway, of a computer case according to the prior art.

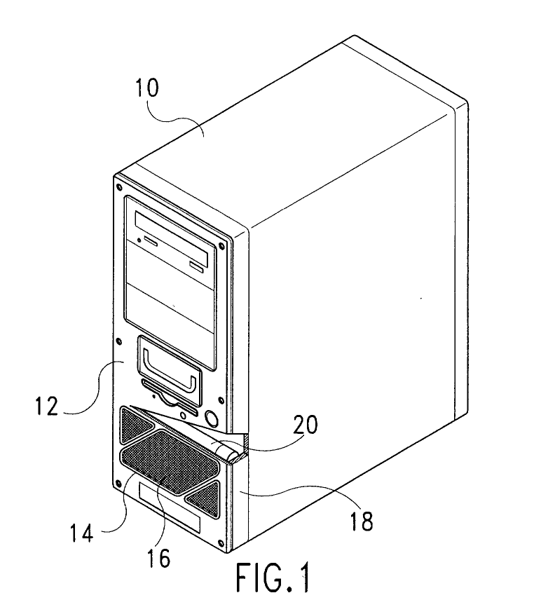

FIG. 2 is an oblique rear elevational view, partially cutaway, of the computer case shown in FIG. 1.

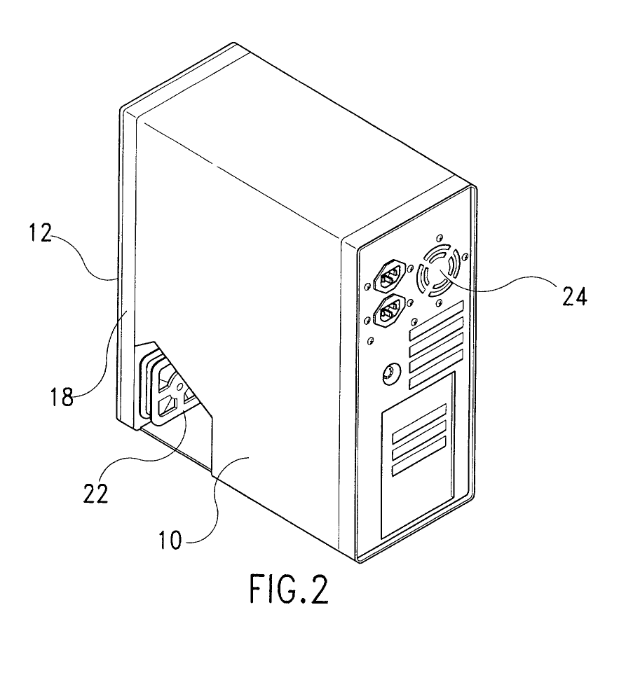

FIG. 3 is an elevational view of a computer case according to the present invention.

FIG. 4 is another elevational view of the computer case according to the present invention.

FIG. 5 is an exploded view of an air purifier according to the present invention.

FIG. 6 is an assembly view of the air purifier shown in FIG. 5 before the connection of the cover to the grilled housing.

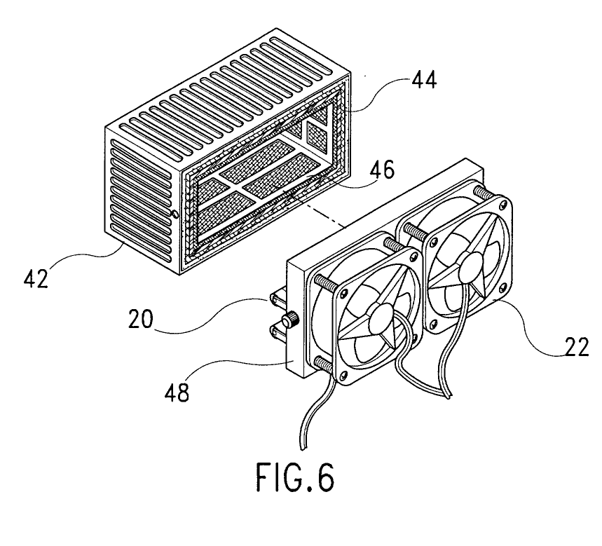

FIG. 7 is an assembly view of FIG. 6.

FIG. 8 illustrates the air purifier installed in the case body of the computer case according to the present invention.

FIG. 9 is an enlarged view of a part of the air filter for the air purifier according to the present invention.

### DETAILED DESCRIPTION OF THE PREFERRED EMBODIMENT

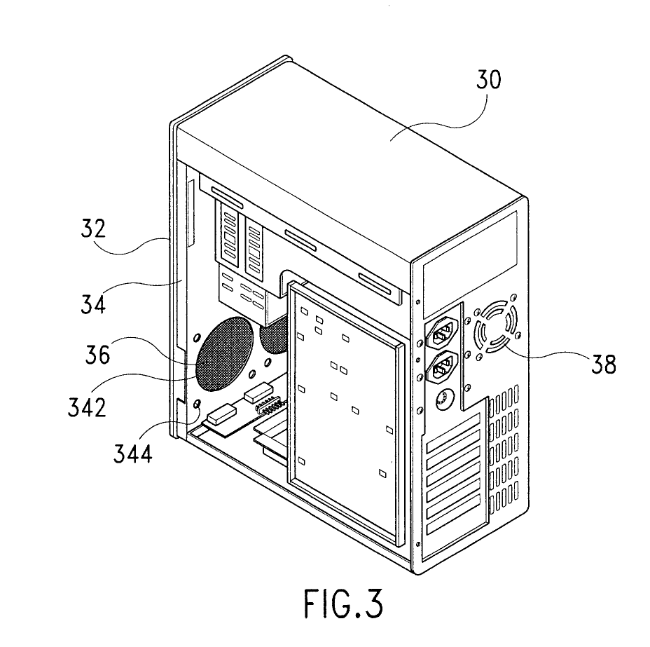

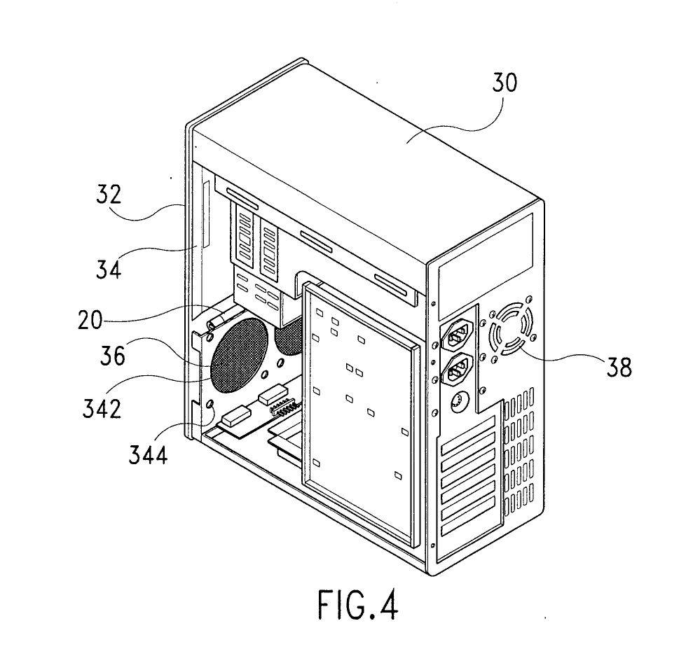

Referring to FIGS. 3 and 4, a device case, for example, a computer case is shown comprising a case body 30. The case body 30 has a front metal face panel 32. The front metal face panel 32 has an air input port (not shown). A vertical inside locating plate 34 is located on the inside of the case body 30 to hold a wire gauze filter 36 in the air input port of the front metal face panel 32. An ultraviolet light source, for example, a tubular ultraviolet lamp 20 is provided in the vertical inside locating plate 34 above the air input port of the front metal face panel 32, and adapted to emit ultraviolet light that sterilizes air passing through the air input port of the front metal face panel 32 and the wire gauze filter 36. The vertical inside locating plate 34 has two openings 342 corresponding to the air input port of the font metal face panel 32, and a plurality of screw holes 344. The inner surface of the front metal face panel 32 and the vertical inside locating plate 34 as well as the wire gauze filter 36 are covered with a layer of photo catalyst, i.e., TiO₂. When radiated by ultraviolet light from the ultraviolet lamp 20, the photo catalyst coating purge germs and peculiar smell from the air passing through. The case body 30 further has an air output port 38 in the back panel thereof.

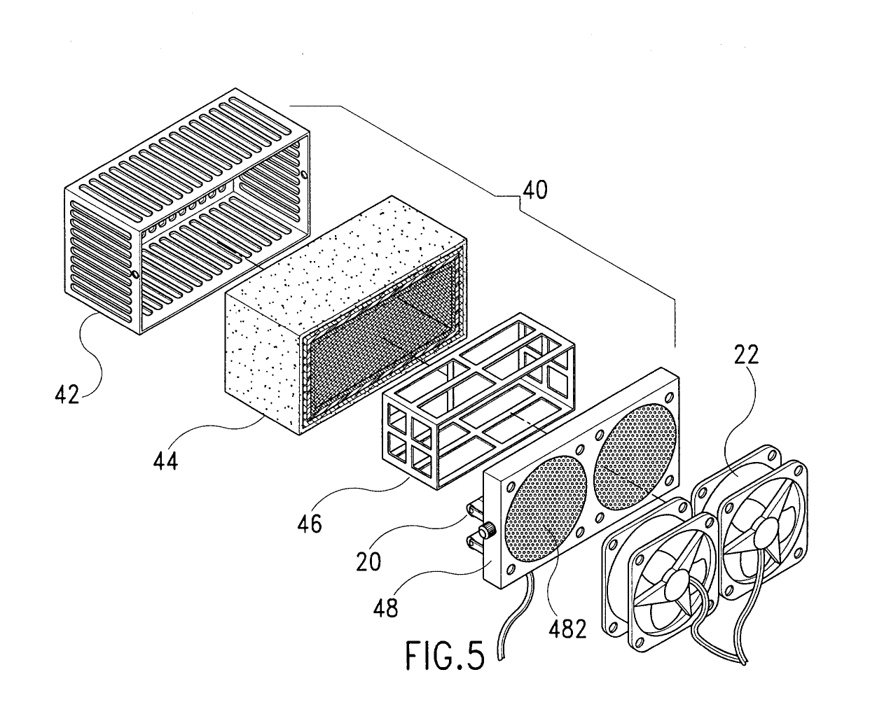

Referring to FIGS. 5˜7, an air purifier 40 is shown comprised of a grilled housing 42, an air filter 44, a rack 46, and a cover 48. The cover 48 has two air passage holes 482. Preferably, the air passage holes 482 are respectively covered with a wire gauze filter. Two ultraviolet lamps 20 are provided at the back side of the cover 48. The air filter 44 is mounted inside the grilled housing 42. After installation of the air filter 44 in the grilled housing 42, the rack 46 is fitted into the inside of the air filter 44. At final, the cover 48 is covered on the grilled housing 42 to hold the rack 46 and the air filter 44 inside the grilled housing 42. Further, before fastening the cover 48 to the grilled housing 42, two induced-draft fans 22 are mounted on the front sidewall of the cover 48 corresponding to the air passage holes 482. The rack 46 supports the air filter 44 firmly inside the grilled housing 42 and, prevents the ultraviolet lamps 20 from contacting the air filter 44 during installation of the cover 48. The ultraviolet lamps 20 can be of any of a variety of ultraviolet light emitting devices.

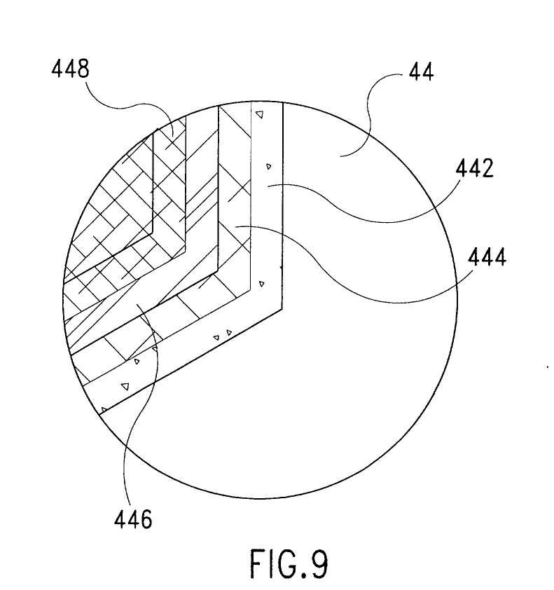

Referring to FIG. 9, the air filter 44 is a box-like member having its structural wall formed of an outer active carbon layer 442, an inner glass fiber layer 448, an intermediate glass fiber layer 444 sandwiched in between the outer active carbon layer 442 and the inner glass fiber layer 448, and an intermediate plastic mesh layer 446 sandwiched in between the intermediate glass fiber layer 444 and the inner glass fiber layer 448. Further, the outer active carbon layer 442, the intermediate glass fiber layer 444, the intermediate plastic mesh layer 446, and the inner glass fiber layer 448 are respective coated with a layer of photo catalyst, i.e., TiO₂. When radiated by ultraviolet light from the ultraviolet lamps 20, the photo catalyst purges germs and peculiar smell from the air passing through.

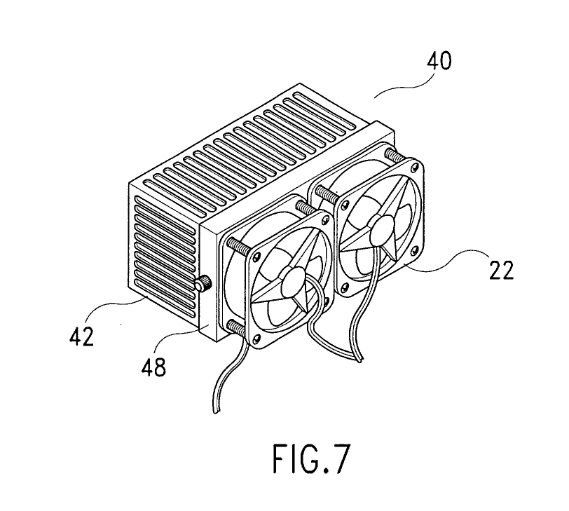

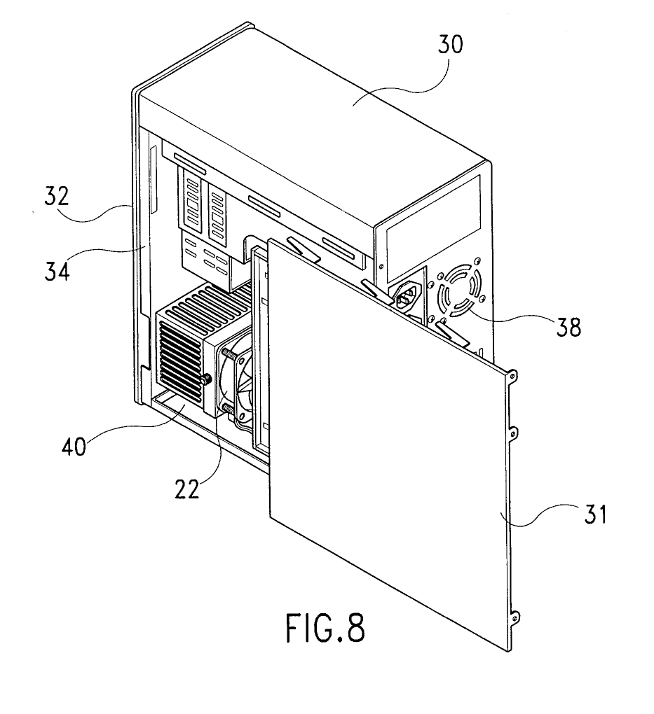

Referring to FIG. 8 and FIGS. 4 and 7 again, the air purifier 40 is fixedly fastened to the screw holes 344 of the vertical inside locating plate 34 of the case body 30 corresponding to the two openings 342 by screws. After installation of the air purifier 40 in the case body 30, the side panel, referenced by 31, is fixedly fastened to the case body 30. When the computer started, the induced-draft fans 22 induce currents of air through the case body 30 in direction from the air input port of the front metal face panel 32 through the air output port 38 via the wire gauze filter 36 and the air purifier 40.

A prototype of air purifying device case has been constructed with the features of FIGS. 3˜9. The air purifying device case functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims. For example, ultraviolet light emitting diodes may be used instead of tubular ultraviolet lamps.

What the invention claimed is:

1. A device case and air purifier arrangement comprising:
a case body, said case body having at least one air port in a front face panel thereof and at least one air output port in a back panel thereof, the front face panel of said case body having an inner side coated with a layer of photo catalyst of titanium dioxide;
a locating plate coated with a layer of photo catalyst of titanium dioxide and fastened to the inner side of said front face panel inside said case body;
at least one ultraviolet light source mounted in said locating plate inside said case body above the at least one air input port of said case body;
a wire gauze filter coated with a layer of photo catalyst of titanium dioxide and mounted in between the front face panel of said case body and said locating plate over the at least one air input port of said case body;
wherein an air purifier is mounted inside said case body and adapted to induce currents of air through the at least one air input port and at least one air output port of said case body and to purify the air passing through, said air purifier comprising a grilled housing coated with a layer of photo catalyst of titanium dioxide and fixedly fastened to said locating plate, an air filter mounted within said grilled housing, a metal rack coated with a layer of photo catalyst of titanium dioxide and mounted inside said grilled housing to support said air filter in place, a cover covered on said grilled housing to hold said rack and said air filter inside said grilled housing, said cover having at least one air passage hole adapted to guide air from the at least one air input port of said case body to the at least one air output port of said case body, at least one ultraviolet light source installed in said cover inside said grilled housing, and at least one induced-draft fan respectively mounted in the at least one air passage hole of said cover.

2. The device case and air purifier arrangement as claimed in claim 1, wherein said air filter of said air purifier is a box-like member having a structural wall formed of an outer active carbon layer, an inner glass fiber layer, an intermediate glass fiber layer sandwiched in between said outer active carbon layer and said inner glass fiber layer, and an intermediate plastic mesh layer sandwiched in between said intermediate glass fiber layer and said inner glass fiber layer.

3. The device case and air purifier arrangement as claimed in claim 1, wherein said ultraviolet light sources are ultraviolet light emitting diodes.
